(19) United States
(12) Patent Application Publication
(10) Pub. No.: US 2012/0085669 A1
(43) Pub. Date: Apr. 12, 2012

(54) Indicator for a Drink Container

(76) Inventors: Michael Diehl, Chicago, IL (US); Jean Janavicius, Chicago, IL (US)

(21) Appl. No.: 13/268,127

(22) Filed: Oct. 7, 2011

Related U.S. Application Data
(60) Provisional application No. 61/390,652, filed on Oct. 7, 2010.

(51) Int. Cl. A61J 9/00; A47G 19/22; B65D 85/00

(52) U.S. Cl. 206/459.1; 215/11.1

(57) ABSTRACT

A drink container, such as a baby bottle, having a time indicator is described. The container includes a body and nipple assembly, and further includes the ability to display a relevant time. The body is suitable for retaining an amount of a drinkable fluid and has an opening therein. The nipple assembly detachably connects to the body over the opening using a securing collar. Alternatively, a detachable lid having a liquid dispensing opening may connect to the body. A numerical array integral to one of either the body, the securing collar or the lid, and an indicator cooperating with the numerical array, wherein at least one of the numerical array and the indicator are movable to align the indicator with any point on the array, provide the ability to indicate a relevant time on the container.

### CROSS-REFERENCE TO RELATED APPLICATIONS

This application claims the benefit of U.S. patent application Ser. No. 61/390,652 filed on Oct. 7, 2010.

### TECHNICAL FIELD OF THE INVENTION

The present invention relates to drink containers, such as baby bottles, sippy-cups and drink bottles typically used by kids and adults. Particularly, the invention relates to devices integral to or retro-fitted on a drink container for indicating an event time, such as, for example, a formula mixing time, a refrigeration time or the like.

### BACKGROUND OF THE INVENTION

With respect to infant drinks, many of the more popular baby formula brands, such as Enfamil® and Similac®, instruct parents to discard formula remaining in the baby bottle after one hour. While the one hour time reference is most likely a rule of thumb rather than a strict feeding practice, some parents do not like to take chances with old formula. Likewise, milk and other drinks also can become spoiled or otherwise turn rancid over longer or shorter periods of time. Unfortunately, the shelf-life of such baby drinks is only helpful if the creation time of the drink is known.

However, it is equally difficult, considering all the things that a caregiver of a bottle-feeding baby may be dealing with at any given time, to remember the exact or even approximate mixing time of a bottled formula or a poured bottle of milk or juice. The ability to track such times may be further complicated by factors such as dealing with multiple bottles due to multiple babies, middle of the night feedings, erratic feeding times, multiple handlers (e.g., parents, sitters, nannies, grandparents, etc.) and other such common occurrences.

Likewise, drinks for older kids and adults, such as health and sports drinks with limited shelf-life, pose similar issues. These drinks may come in their own bottle containers, or they may be mixed by a user.

In light of these concerns and unknowns, a fair amount of expensive formula or other drinks are wasted. Perhaps even more alarming is that a fair amount of spoiled drinks, such as dairy and non-dairy based formulas and fruit drinks, may be consumed every day just because there is no clear indication the drink has gone bad and the elapsed time from mixing or refrigeration is unknown. Generally speaking, babies and young children do not have well-developed immune systems, nor do they always have sufficiently developed digestive systems. Adults, for other reasons, may also have compromised immunities or digestive systems. Either may be upset by soured or spoiled drinks.

The present invention solves these and other problems associated with prior art devices. Multiple embodiments of a time indicator for a drink container are presented which have additional design and manufacturing advantages over prior art devices.

### SUMMARY OF THE INVENTION

A number of embodiments of a drink container having a time indicator are herein described. The container is generally comprised of a body and the ability to display a relevant time.

In an embodiment, a spout or nipple assembly, including a securing collar is used in conjunction with the container body. Alternatively, a detachable lid having a drink dispensing opening may be used.

Accordingly, in one embodiment of the disclosed device, the container comprises a body for retaining a drinkable fluid and having an opening, a nipple (or spout) assembly detachably connectable to the body over the opening by a securing collar, a numerical array integral to at least one of either the body or the securing collar, and an indicator cooperating with the numerical array, wherein at least one of the numerical array and the indicator are movable to align the indicator with any point on the array.

In alternate embodiments, a detachable lid is used to replace the nipple assembly. The lid and container body would comprise a numerical array integral to at least one of either the body or the lid, and an indicator cooperating with the numerical array, wherein at least one of the numerical array and the indicator are movable to align the indicator with any point on the array.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated. Certain features, work pieces and environment of some figures have been omitted or shown in broken lines so as not to obscure other features of the figures.

FIG. 1 is a side view of a first embodiment of the present device;

FIG. 2 is a side view of a second embodiment of the present device;

FIG. 3 is a side view of a third embodiment of the present device;

FIG. 4 is a side view of a fourth embodiment of the present device;

FIG. 5 is a side and bottom view of a fifth embodiment of the present device;

FIG. 6 is a side and bottom view of a sixth embodiment of the present device; and

FIG. 7 is a side and bottom view of a seventh embodiment of the present device.

### DETAILED DESCRIPTION OF THE INVENTION

While this invention is susceptible of embodiments in many different forms, there is shown in the drawings and will herein be described in detail, preferred embodiments of the invention with the understanding that the present disclosure is to be considered as an exemplification of the principles of the invention and is not intended to limit the broad aspect of the invention to the embodiments illustrated. While the invention is described and illustrated in combination with a standard baby bottle, it should be understood that the features of the invention could be applied to baby bottles of many different types, styles and sizes, not necessarily just reusable bottles, but disposable bottles as well.

For purposes of the description, the various components of the invention are commonly numbered through the illustrated embodiments, with the exception that the first digit between common elements reflects the embodiment to which the element pertains—for example, element 21 would be element 121 in a first embodiment, element 221 in a second embodiment, 321 in a third embodiment, etc.

While the following description and the referenced drawing figures exclusively reference a baby bottle, it is understood that some of the described embodiments are easily applicable to other types of drink containers. Such containers might include, for example, disposable and reusable water bottles, drink mixers, cans, mugs, glasses, and disposable fountain drink cups.

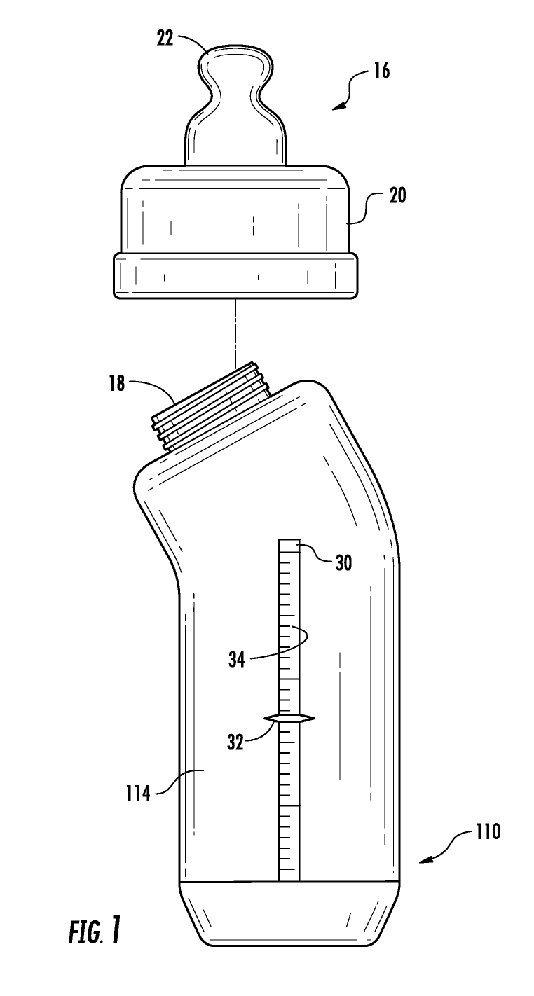

Referring to FIGS. 1-7, there is illustrated several embodiments of a baby bottle 10 having a reusable time indicator 12. Generally speaking, the baby bottle comprises a body 14 and a detachable nipple assembly 16. The body 14 may be any type, size or style of known bottle, including plastic, glass, reusable, disposable, ergonomic, tall, short, cylindrical, etc. The body 14 includes an opening 18 which may have a snap-fit or threaded neck for attachment of the nipple assembly 16.

The nipple assembly 16 is comprised of a securing collar 20 and a nipple 22. The securing collar 20 attaches to the neck of the opening 18 of the bottle body 14 to secure the nipple 22 over the opening. The collar 20 may, of course, attach via a snap-fit connection, by threaded surfaces, or by any other manner known and used. The nipple 22 may be of any known type, size or style and forms no part of the present invention.

With reference to FIG. 1, the baby bottle 110 is shown having a groove 30 in the sidewall of the body 114. Within the groove 30 is secured a sliding mechanism which acts as an indicator 32. Within the groove 30 are indicia 34 which correspond to a 12-hour period array (e.g., 12:00, 1:00, 2:00, etc.) having increments in the range of from 1 minute to 30 minute intervals. The numerical array may be as simple as whole numbers to represent hours (e.g., 1, 2, 3, 4, etc.) with standard hash marks there between to indicate half, quarter, or tenths of hours. The indicia 34 may be embossed, raised, or printed onto the bottle sidewall. Additionally, the indicia 34 may be positioned along an edge of the groove 30, so long as it coincides with the sliding indicator 32. Those skilled in the art would understand the mechanical aspects of the groove 30 and residing indicator 32. To mark a time, the indicator 32 can be slid up or down in the groove 30 until it aligns with the desired numerical (or hash mark) indicia of the numerical time array.

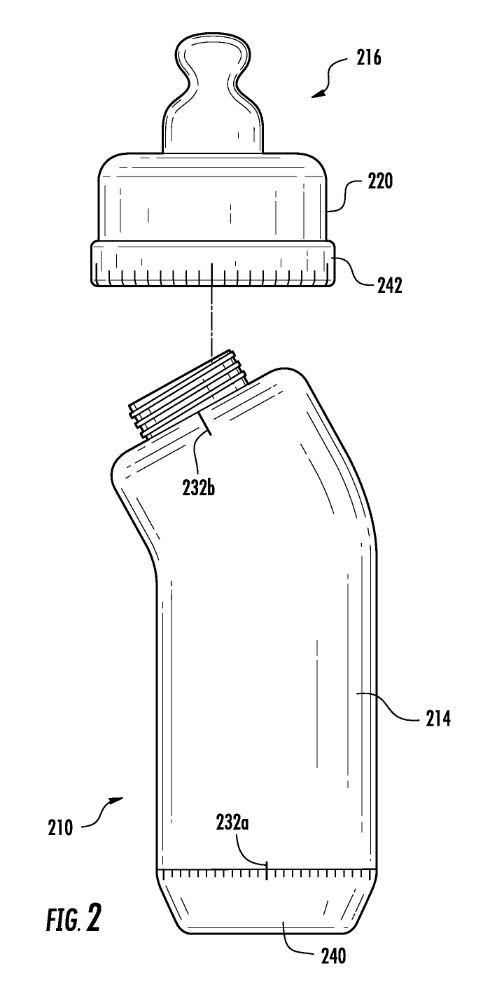

FIG. 2 is an illustration showing two alternate embodiments of the baby bottle 210. Both embodiments are comprised of a bottle body 214 and a nipple assembly 216. In one of the embodiments shown, a base 240 of the body 214 is rotatable, either partially or fully, and includes the numerical array as described above. A fixed indicator 232a is adjacent the rotatable base 240 to allow a time to be marked. The second embodiment of FIG. 2 is very similar, having a two-part securing collar 220 with a rotatable ring 242. The rotatable ring 242 includes the numerical array and an adjacent fixed indicator 232b is positioned on the body 214.

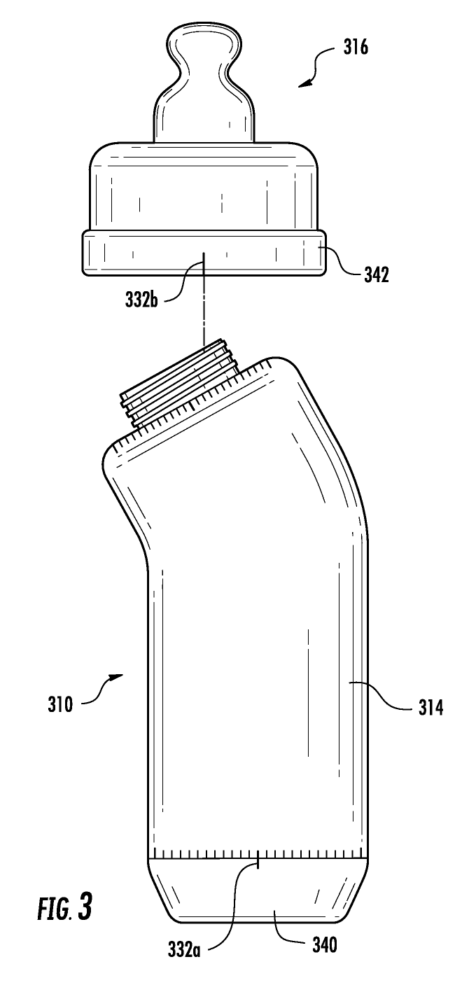

FIG. 3 is an illustration showing two more alternate embodiments of the baby bottle 310. These embodiments are functionally identical to the embodiments of FIG. 2, except the numerical array is fixed onto either end of the bottle body 314 and the rotatable base 340 or rotatable ring 342 include an indicator 332 to move for alignment with a number (or hash mark) on the array.

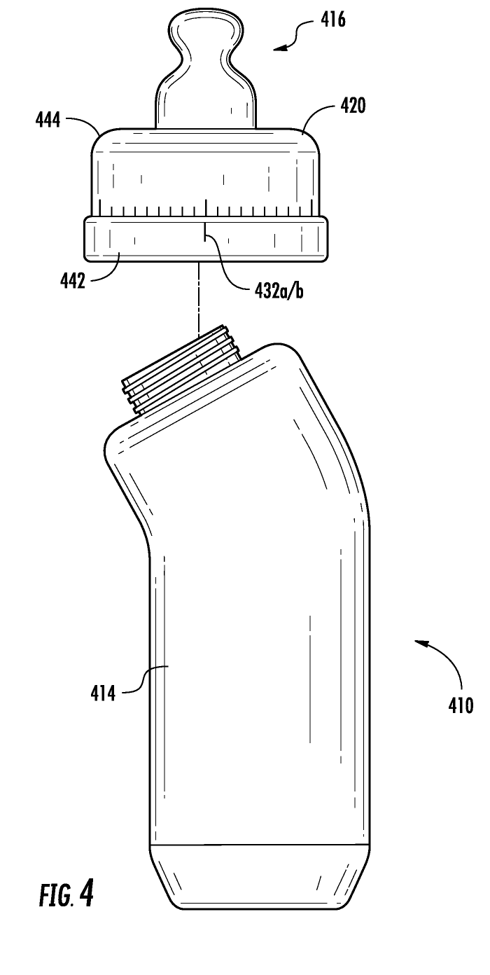

FIG. 4 is an illustration of another embodiment of the baby bottle 410. A two-part securing collar 420 on the nipple assembly 416 includes the numerical array on one of either the rotatable ring 442 or fixed ring 444 and an indicator 432a/b on the other. Again, rotation of the rotatable ring 442 allows the indicator 432a/b to align with a number on the array to indicate a time.

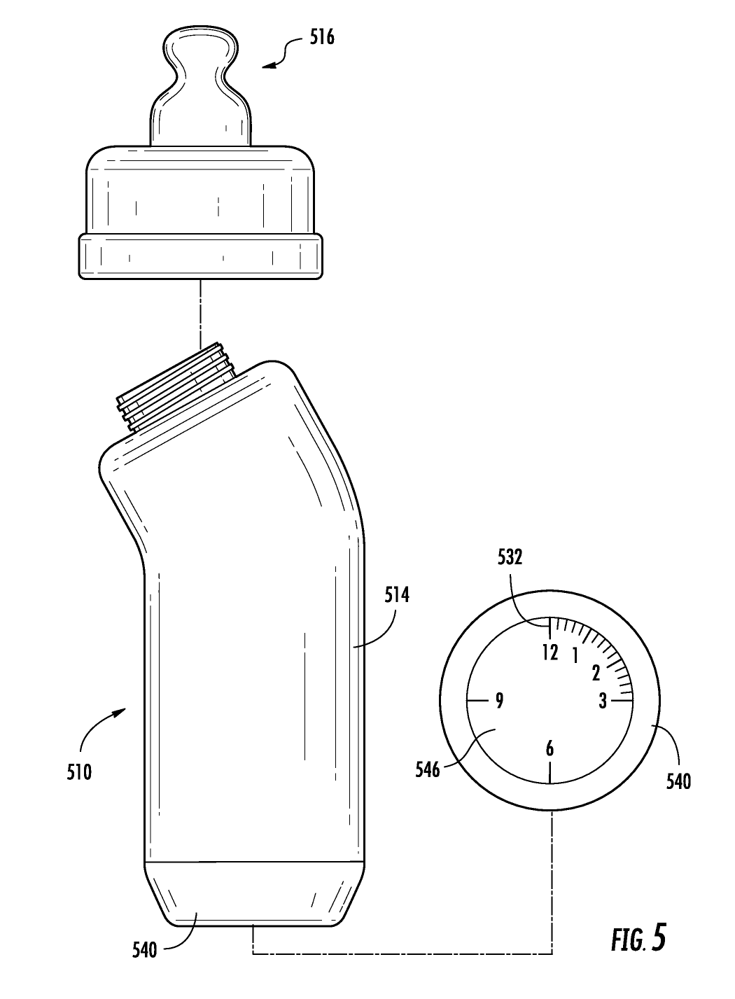

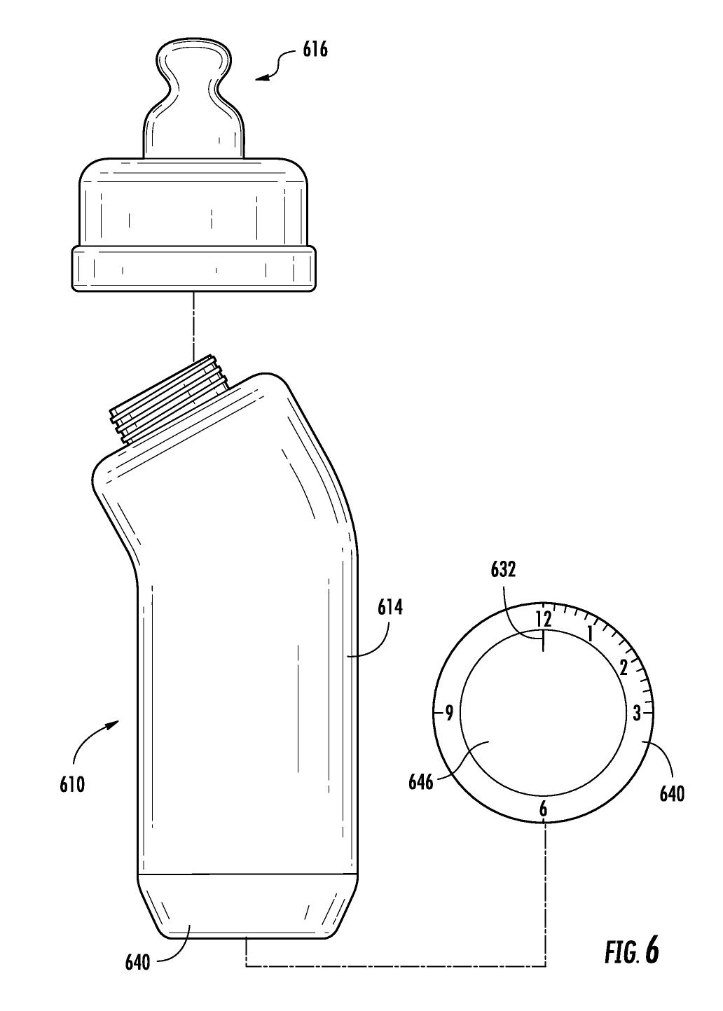

In FIG. 5, another alternate embodiment is illustrated for baby bottle 510. In this embodiment the base 540 is again rotatable, except a bottom face 546 is fixed. The bottom face 546 is shown to include the numerical array—similar to a clock face—with an indicator on the rotatable base 540. The numerical array and indicator 532 may switch positions, as with previously described embodiments, as shown in FIG. 6.

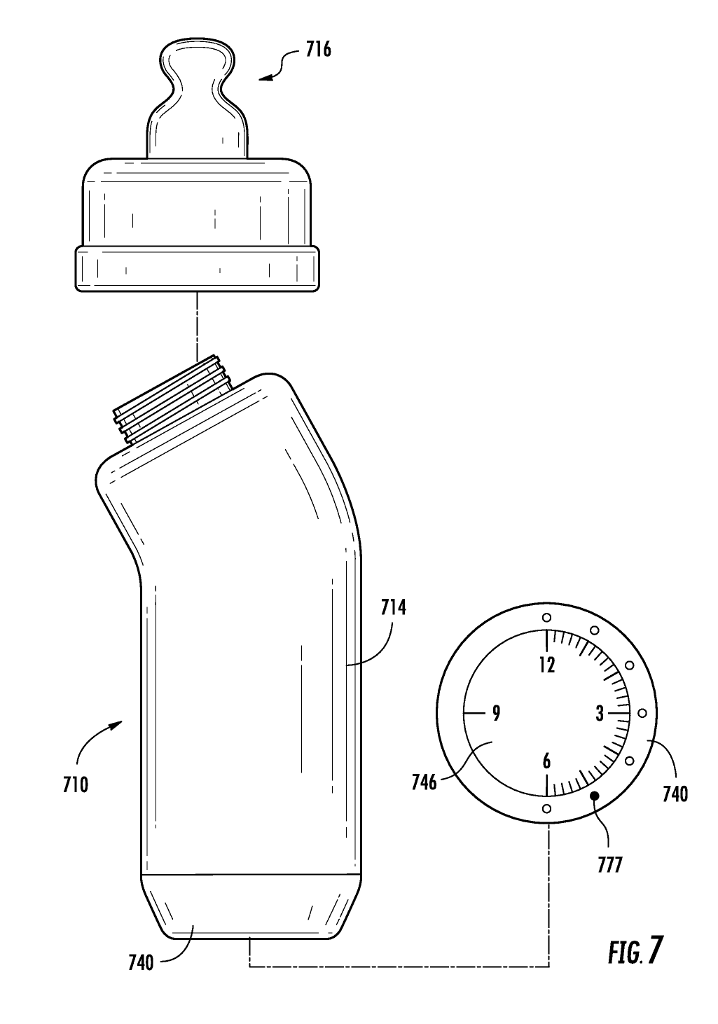

Finally, FIG. 7. is similar to the embodiment of FIG. 5 with the addition of an opening in the rotatable base 740 combined with a colored, spring-loaded button 777 secured within the base 740. The button 777 acts as the indicator 732. By depressing the button 777, the base 740 may then be rotated to align the button 777 with the appropriate time on the fixed bottom face 746. When aligned, the button 777 is released and it will pop-up and lock the rotatable base 740 in place.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A drink container comprising:
a body for retaining a drinkable fluid and having an opening;
one of either a dispensing spout or nipple detachably connectable to the body over the opening by a securing collar;
a numerical array comprised of a plurality of distinct points integral to at least one of either the body or the securing collar; and
an indicator cooperating with the numerical array, wherein at least one of the numerical array and the indicator are movable to align the indicator with a point on the array.

2. The drink container of claim 1, wherein the numerical array comprises a linear display on the body.

3. The drink container of claim 1, wherein the numerical array comprises a circular display on the body.

4. The drink container of claim 1, wherein the numerical array comprises a circular display on the collar.

5. The drink container of claim 1, further comprising a rotatable base.

6. The drink container of claim 5, wherein the numerical array comprises a circular display on the rotatable base.

7. The drink container of claim 5, wherein the base has an opening on a bottom side.

8. The drink container of claim 7, wherein the numerical array is set within the opening on the bottom side.

9. The drink container of claim 1, wherein the indicator comprises a fixed line on the body.

10. The drink container of claim 1, wherein the indicator comprises a fixed line on the collar.

11. The drink container of claim 1, wherein the indicator is slidable.

12. The drink container of claim 1, wherein the numerical array comprises embossed indicia.

13. The drink container of claim 1, wherein the numerical array comprises raised indicia.

14. The drink container of claim 1, wherein the numerical array comprises a 12 hour numerical range.

15. The drink container of claim 14, wherein the 12 hour numerical range is displayed in increments in the range of from 1 to 30 minutes.

16. The drink container of claim 1, wherein the body comprises a baby bottle.

17. The drink container of claim 1, wherein the body comprises a child drink cup.

18. A baby bottle comprising:
a body for retaining a drinkable fluid and having a bottom and an opening;
a nipple detachably connectable to the body over the opening by a securing collar;
a rotatable base attached to the body approximate the bottom and generally opposite the opening;
a numerical array integral to at least one of either the body, the securing collar, or the rotatable base; and
an indicator cooperating with the numerical array, wherein one of either the numerical array, the indicator, or both are movable to align the indicator with any point on the array.

19. A drink container comprising:
a body for retaining a drinkable fluid and having an opening;
a detachable lid connectable to the body over the opening;
a numerical array comprised of a plurality of distinct points integral to at least one of either the body or the detachable lid; and
an indicator cooperating with the numerical array, wherein at least one of the numerical array and the indicator are movable to align the indicator with a point on the array.
